(19) United States
(12) Patent Application Publication
(10) Pub. No.: US 2021/0250345 A1
(43) Pub. Date: Aug. 12, 2021

(54) SYSTEMS AND METHODS FOR AUTHENTICATION USING DYNAMIC, MACHINE-READABLE AUTHENTICATION TOKENS

(71) Applicant: JPMORGAN CHASE BANK, N.A., New York, NY (US)

(72) Inventors: Jason S. THACKER, Cypress, TX (US); Hai Van NGUYEN, Houston, TX (US); Nicholas R. ADAM, The Woodlands, TX (US); Binh NGUYEN, Sugarland, TX (US); Andrew J. MULLIN, Cypress, TX (US)

(21) Appl. No.: 16/784,101

(22) Filed: Feb. 6, 2020

(51) Int. Cl. H04L 29/06; H04L 9/08; H04L 9/32; G06F 3/16; G16Y 40/50; H04W 4/02

(52) U.S. Cl. CPC H04L 63/0838; H04L 9/0869; H04L 63/0853; H04W 4/025; G06F 3/162; G16Y 40/50; H04L 9/3213

(57) ABSTRACT

Systems and methods for authentication using dynamic, machine-readable authentication tokens are disclosed. According to one embodiment, an electronic multifactor authentication token may include a user input device configured to receive a user input, a location sensing device configured to receive a location-based modifier, at least one computer processor configured to generate a one-time passcode based on the user input and the location-based modifier, and an output device configured to output the one-time passcode.

### BACKGROUND OF THE INVENTION

### 1. Field of the Invention

Embodiments generally relate to systems and methods for authentication using dynamic, machine-readable authentication tokens.

### 2. Description of the Related Art

Multi-factor authentication is used with any device types to authenticate a user seeking to use the device. Because it is the lowest common denominator for many device types, multi-factor security tokens often use a simplistic four to eight-digit number as the authenticating key value. Such simplistic numeric keys have inherent weaknesses in both their key space, as well as the fact that they can be moved easily over a number of channels (e.g. can be read over the phone).

In addition, the manual entry process and limited input/output options provide a poor user experience, which limits widespread adoption of multi-factor authentication.

Stronger key types are difficult to input to different devices, or require interfaces (e.g. USB) that aren't present or trustable on all common endpoint devices.

### SUMMARY OF THE INVENTION

Systems and methods for authentication using dynamic, machine-readable authentication tokens are disclosed. According to one embodiment, an electronic multifactor authentication token may include a user input device configured to receive a user input, a location sensing device configured to receive a location-based modifier, at least one computer processor configured to generate a one-time passcode based on the user input and the location-based modifier, and an output device configured to output the one-time passcode.

In one embodiment, the user input device may include a touchscreen, at least one key, a microphone, etc. The user input device may be separate from the multifactor authentication token, and may include a card reader, a keypad, an Internet of Things device, etc.

In one embodiment, the location-based modifier may be based on beacon information, GPS information, a user input, a machine-readable code, etc.

In one embodiment, the output device may be a radio.

In one embodiment, the output device may communicate the one-time passcode to an authentication server and/or an endpoint device.

In one embodiment, the electronic multifactor authentication token may include an image capture device that receives a machine-readable code.

In one embodiment, the electronic multifactor authentication token may further include a memory storing a seed, and the one-time passcode is may be generated based on the location-based modifier and the seed.

According to another embodiment, in an electronic multifactor authentication token comprising at least one computer processor, a method for authentication using an electronic multifactor authentication token may include: (1) receiving a location-based modifier; (2) receiving a seed or user input; (3) generating a one-time passcode based on the location-based modifier and the seed or user input; and (4) communicating the one-time passcode to an endpoint device. The endpoint device may validate the one-time passcode with an authentication server.

In one embodiment, the location-based modifier may be a stored. location or a user input. The location-based modifier may be a GPS location. The location-based modifier may be received from a beacon.

In one embodiment, the seed may be retrieved from a memory of the electronic multifactor authentication token.

In one embodiment, the method may further include communicating the one-time passcode to the authentication server.

In one embodiment, the authentication server may compute a second one-time passcode and may authenticate the one-time passcode received from the endpoint device by comparing the one-time passcode received from the endpoint device to the second one-time passcode.

According to another embodiment, a system for multifactor authentication may include a multifactor authentication token that generates a one-time passcode based on a location-based modifier and one of a user input and a seed, an endpoint device that receives the one-time passcode from the multifactor authentication token, and an authentication server that authenticates the one-time passcode.

In one embodiment, the location-based modifier may include a stored location, a user input, a GPS location, etc.

In one embodiment, the multifactor authentication token may communicate the one-time passcode to the authentication server, and the authentication server may authenticate the one-time passcode by comparing the one-time passcode received from the endpoint device to the one-time passcode received from the multifactor authentication token.

In one embodiment, the authentication server may compute a second one-time passcode, and may authenticate the one-time passcode received from the endpoint device by comparing the one-time passcode received from the endpoint device to the second one-time passcode.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a dynamic, machine-readable authentication token system is disclosed according to one embodiment;

FIG. 2 depicts a method for authentication with a dynamic, machine-readable authentication token is disclosed according to one embodiment.

### DETAILED DESCRIPTION OF PREFERRED EMBODIMENTS

Embodiments are related to dynamic, machine-readable authentication tokens.

Embodiments may increase the amount of information able to be passed by the token to the endpoint device, enabling both a stronger key value and the inclusion of enriching data points that further validate the user's authentication.

Embodiments may use a device with a plurality of input/output options as a multifactor authentication token, as key value for which may be input in a number of different ways depending on the endpoint device type.

By increasing the effective bandwidth available for the multifactor authentication key, additional authenticating information may be passed to the endpoint device.

In one embodiment, the ubiquity of cameras and/or Bluetooth on most devices allows those devices to receive the key from the token as, for example, a machine-readable code (e.g., a two-dimensional barcode), wirelessly via Bluetooth (e.g., Bluetooth Low Energy, or BLE). In one embodiment, larger devices (e.g., desktop computers, workstations, etc.) may use a USB interface and the token may be treated as, for example, a smart card, a human input device, etc.

In embodiments, the multifactor authentication token may make a parallel connection to a back-end authentication service for interactive challenge-response instead of a time-based cryptographic verification.

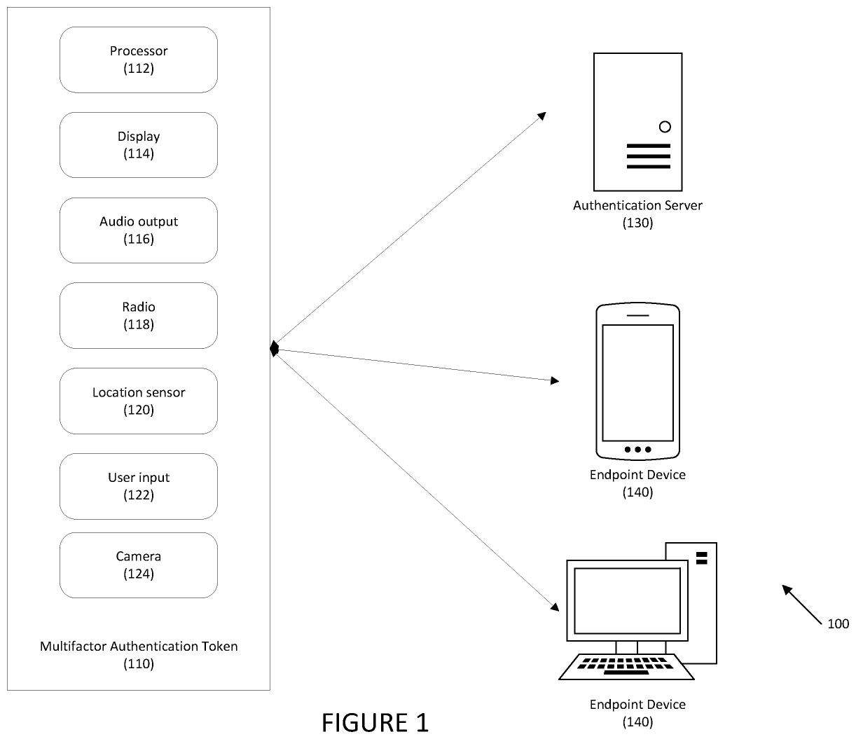

Referring to FIG. 1, a dynamic, machine-readable authentication token system is disclosed according to one embodiment. System 100 may include multifactor authentication token 110, authentication server 130, and one or more endpoint device 140.

Multifactor authentication token 110 may be a hardware device that includes processor 112, display 114, audio output 116, radio 118, location. sensor 120, user input 122, and camera 124. In one embodiment, processor 112 may be any suitable computer processor, integrated circuit, etc. that may receive and/or process information from any other component in multifactor authentication token 110 and manage communications with authentication server 130 and/or endpoint device(s) 140.

Display 114 may be any suitable display that may display information e.g., a machine-readable code) for endpoint device(s) 140. In one embodiment, display 114 may communicate information and/or instructions to the user.

Audio output 116 may be any suitable audio output device that may communicate with the user, and/or may provide an audio output for endpoint device(s) 140. For example, audio output may communicate a one-time password as an audio signal.

Radio 118 may be any suitable device that provides RF communication, including WiFi, Bluetooth, NFC, cellular, or any other suitable format. Radio 118 may send and receive RF signals and may communicate with authentication server 130 and/or endpoint device(s) 140. In one embodiment, radio 118 may communicate with location-indicating devices, such as beacons (not shown), GPS satellites (not shown), cellular towers (not shown), hotspots (not shown), etc.

Location sensor 120 may sense a location of multifactor authentication token 110. For example, location sensor 120 may receive information from radio 118 (e.g., beacon information, GPS location, RFID location, etc.), from user input 122 (e.g., a manually-entered location), and/or camera 124 (e.g., a code associated with the location) in order to determine a location for multifactor authentication token 110.

User input device 122 may be any suitable device for receiving user input, including a touchscreen (e.g., display 114 has touch capabilities), a microphone (not shown), camera 124, one or more keys (not shown), etc.

In one embodiment, user input device 122 may be a separate or remote device (e.g., a card reader, keypad, IoT device, etc.) from multifactor authentication token 110, and may transmit the user input multifactor authentication token 110.

Camera 124 may be any suitable device for capturing an image or images. In one embodiment, camera 124 may capture an image of a machine-readable code (not shown) for processing by processor 112.

Authentication server 130 may be a server in communication with multifactor authentication token 110 and/or endpoint device(s) 140.

Endpoint device(s) 140 may be any electronic device to which access may be restricted. For example, endpoint device(s) 140 may include computers (e.g., workstations, desktops, laptops, tablets, etc.), smartphones, smart watches, Internet of Things (IoT) devices, databases, thin clients, on-line resources, etc.

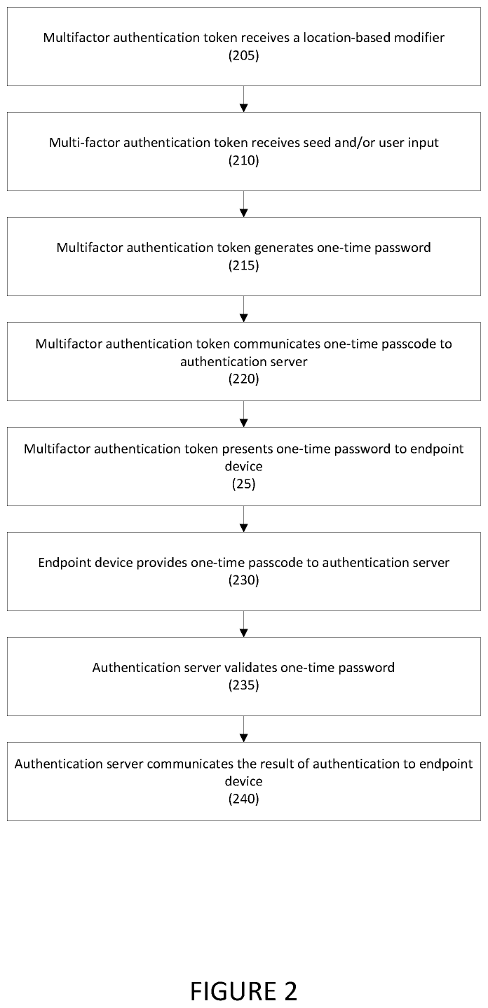

Referring to FIG. 2, a method for authentication with a dynamic, machine-readable authentication token is disclosed according to one embodiment.

In step 205, a multifactor authentication token may receive one or more location-based modifier. In one embodiment, the location-based modifier may be provided manually (e.g., a user may input a location, such as a zip code, a stored location, etc.). In another embodiment, the multifactor authentication token may receive a beacon, such as a Bluetooth Low Energy signal, LoRa, or any other suitable RF communication), a GPS location, cellular signals for cellular triangulation, etc. In another embodiment, the multifactor authentication token may be detected, or may detect, a MD or proximity reader. In another embodiment, the location of the multifactor authentication token may be detected by cameras in the area (e.g., closed circuit television, etc.) and the location may be provided to the multifactor authentication token. In another embodiment, a 1-wire button (e.g., an iButton) that may provide a unique identifier that may be associated with a location may be used. Any other suitable manner of receiving a location identifier may be used as is necessary and/or desired.

In step 210, the multifactor authentication token may receive one or more seed or user input. In one embodiment, the seed may be an elliptical curve seed and/or a standard modifier, such as an embedded seed (e.g., a seed stored in memory or permanent storage, a trusted platform module (TPM) chip token, etc.), a time-based seed, a user personal identification number or similar entry, a biometric (e.g., stored by the multifactor authentication token or received by the multifactor authentication token), etc.

In step 215, the multifactor authentication token may generate a one-time passcode using the one or more location-based modifier and the one or more seed and/or user input. Any suitable algorithm may be used to generate the one-time password.

In step 220, the multifactor authentication token may communicate the one-time password to, for example, an authentication server. In one embodiment, this may be optional.

In step 225, the multifactor authentication token may present the one-time passcode to an endpoint device. In one embodiment, the one-time passcode may be presented as an optical machine-readable code (e.g., a two-dimensional barcode), as an audible code, as a RF transmission (e.g., Bluetooth, WiFi, NFC, etc.), or as any other code that may be communicated from the multifactor authentication token to the endpoint device.

In step 230, the endpoint device may provide the one-time password to the authentication server, and, in step 235, the authentication server may validate the one-time password provided by the token to the endpoint device.

In step 240, the authentication server may communicate the result of the authentication to the endpoint device. The endpoint device may then take the appropriate action (e.g., grant or deny access) as is necessary and/or desired.

Although multiple embodiments have been disclosed, it should be recognized that these embodiments are not mutually exclusive, and features from one may be used with another.

Hereinafter, general aspects of implementation of the embodiments will be described.

Embodiments of the invention or portions of thereof may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. An electronic multifactor authentication token, comprising:
a user input device configured to receive a user input;
a location sensing device configured to receive a location-based modifier;
at least one computer processor configured to generate a one-time passcode based on the user input, the location-based modifier, and the machine-readable code; and
an output device configured to output the one-time passcode.

2. The electronic multifactor authentication token of claim 1, wherein the user input device comprises at least one of a touchscreen, at least one key, and a microphone.

3. The electronic multifactor authentication token of claim 1, wherein the user input device is separate from the multifactor authentication token.

4. The electronic multifactor authentication token of claim 3, wherein the user input device comprises at least one of a card reader, a keypad, and an Internet of Things device.

5. The electronic multifactor authentication token of claim 1, wherein the location-based modifier is based on one of beacon information, GPS information, a user input, and a machine-readable code.

6. The electronic multifactor authentication token of claim 1, wherein the output device comprises a radio.

7. The electronic multifactor authentication token of claim 1, wherein the output device communicates the one-time passcode to at least one of an. authentication server and an endpoint device.

8. The electronic multifactor authentication token of claim 1, further comprising:
an image capture device configured to receive a machine-readable code.

9. The electronic multifactor authentication token of claim 1, further comprising a memory storing a seed, and wherein the one-time passcode is generated based on the location-based modifier and the seed.

10. A method for authentication using an electronic multifactor authentication token, comprising:
in an electronic multifactor authentication token comprising at least one computer processor:
receiving a location-based modifier;
receiving a seed or user input;
generating a one-time passcode based on the location-based modifier and the seed or user input; and
communicating the one-time passcode to an endpoint device;
wherein the endpoint device validates the one-time passcode with an authentication server.

11. The method of claim 10, wherein the location-based modifier comprises a stored location or a user input.

12. The method of claim 10, wherein the location-based modifier comprises a GPS location.

13. The method of claim 10, wherein the location-based modifier is received from a beacon.

14. The method of claim 10, wherein the seed is retrieved from a memory of the electronic multifactor authentication token.

15. The method of claim 10, further comprising:
communicating the one-time passcode to the authentication server.

16. The method of claim 10, wherein the authentication server computes a second one-time passcode and authenticates the one-time passcode received from the endpoint device by comparing the one-time passcode received from the endpoint device to the second one-time passcode.

17. A system for multifactor authentication, comprising:
a multifactor authentication token that generates a one-time passcode based on a location-based modifier and one of a user input and a seed;
an endpoint device that receives the one-time passcode from the multifactor authentication token; and
an authentication server that authenticates the one-time passcode.

18. The system of claim 17, wherein the location-based modifier comprises a stored location, a user input, and a GPS location.

19. The system of claim 17, wherein the multifactor authentication token communicates the one-time passcode to the authentication server, and the authentication server authenticates the one-time passcode by comparing the one-time passcode received from the endpoint device to the one-time passcode received from the multifactor authentication token.

20. The system of claim 17, wherein the authentication server computes a second one-time passcode and authenticates the one-time passcode received from the endpoint device by comparing the one-time passcode received from the endpoint device to the second one-time passcode.
